(19) United States
(12) Patent Application Publication
(10) Pub. No.: US 2010/0131918 A1
(43) Pub. Date: May 27, 2010

(54) METHOD FOR GENERATING A UML OBJECT DIAGRAM OF AN OBJECT-ORIENTED APPLICATION

(75) Inventors: Christopher N. Bailey, Hampshire (GB); Flavio A. Bergamaschi, Hampshire (GB)

Correspondence Address: CANTOR COLBURN LLP - IBM RSW, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/324,023

(22) Filed: Nov. 26, 2008

(51) Int. Cl. G06F 9/44

(52) U.S. Cl. 717/105

(57) ABSTRACT

A method for generating a UML object diagram of an object-oriented application is provided. The method includes executing the object-oriented application. The method further includes obtaining a copy of a memory address space of the application while the object-oriented application is being executed. The method further includes generating an object relationship graph based on the copy of the memory address space. The method further includes generating the UML object diagram of the object-oriented application based on the object relationship graph. The method further includes storing the UML object diagram in a memory device.

### BACKGROUND

The present application is directed to a method for generating a unified modeling language (UML) object diagram of an object-oriented application.

When modifying pre-existing software code, development teams try to understand a functionality of the existing software code. In an ideal situation, a development team can access specifications and documented source code. However, in some instances, the specifications do not match the actual implemented software code or the software code is not well documented.

One method of to visually illustrate a functionality of an object-oriented application is to generate a UML class diagram. Currently, UML class diagrams can be generated using either static source code analysis or a debugger. A drawback with the static source code analysis is that many times the source code is not available. The drawback of the debugger is that the debugger requires a generation of production-like test cases in order to stimulate the application.

Accordingly, the inventors herein have recognized a need for an improved method of generating a UML object diagram that minimizes and/or eliminates the above-mentioned deficiencies.

### SUMMARY

A method for generating a UML object diagram of an object-oriented application in accordance with an exemplary embodiment is provided. The method includes executing the object-oriented application. The method further includes obtaining a copy of a memory address space of the application while the object-oriented application is being executed. The method further includes generating an object relationship graph based on the copy of the memory address space. The method further includes generating the UML object diagram of the object-oriented application based on the object relationship graph. The method further includes storing the UML object diagram in a memory device.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 is a schematic of a system for generating a UML object diagram in accordance with an exemplary embodiment;

FIG. 2 is a schematic of an exemplary object relationship graph utilized by the system of FIG. 1;

FIG. 3 is a schematic of a UML object diagram utilized by the system of FIG. 1; and

FIGS. 4 and 5 are flowcharts of a method for generating a UML object diagram in accordance with another exemplary embodiment.

### DETAILED DESCRIPTION

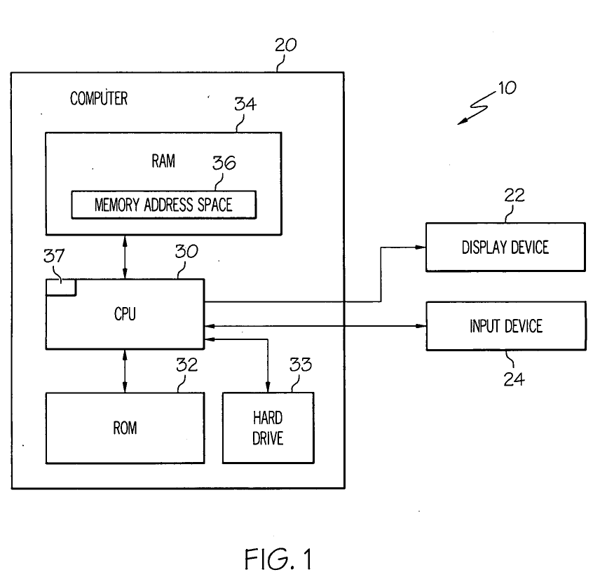

Referring to FIG. 1, a system 10 for generating a UML object diagram associated with a software application in accordance with an exemplary embodiment is provided. The system 10 includes a computer 20, a display device 22, and an input device 24. The computer 20 includes a central-processing unit (CPU) 30 operably coupled to a read-only-memory (ROM) 32, a random access memory (RAM) 34, and a hard-drive 32. The RAM 34 includes a memory address space 36 that is utilized by a software application 37 executing on the CPU 30. The input device 24 is configured to allow a user to input data that is received by the computer CPU 30. The display device 22 is configured to display data and messages generated by the CPU 30.

The general overview of the operation of the system 10 will now be explained. Initially, the object-oriented software application 37 is executed by the CPU 30 in the memory address space 36. A memory snapshot of the executing software application 37 is obtained utilizing either a system dump (e.g., a core file, a minidump, a svcdump) or a heap dump. Thereafter, the computer 20 performs a directed graph analysis of the software objects in either the system dump or the heap dump to generate an object relationship graph. An object relationship graph illustrates object relationships and dependencies of a software application. In one exemplary embodiment, the computer 20 generates the object relationship graph 50, which will be explained in greater detail below. Thereafter, the computer 20 generates a UML object diagram (also referred to as a UML class diagram) based on the object relationship graph. A UML object diagram has object elements corresponding to objects in the application.

From the heap dump or memory dump, the UML object diagram illustrates object elements corresponding to objects in the executing software application. The object elements have names that identify a type of an object stored in a heap dump or system dump.

The UML object diagram can further illustrate object attributes. The object attributes correspond to field names associated with an object. It should be noted that with .txt and .phd heap dumps, only reference field names are available. For HPROF format heap dumps and for system dumps, a full field name and associated value is available for both primitive fields and reference fields.

The UML object diagram can further illustrate multiplicity. Multiplicity corresponds to multiple objects of a same type being grouped together when individual attributes associated with the objects are not important. Multiplicity analysis can be performed by analyzing object arrays in memory dumps, wherein each object array is identified by an object type.

The UML object diagram can further illustrate links and associations between objects in a heap dump or a system dump, which are also used to generate vectors in a directed graph analysis. A link is therefore a vector, which is also a reference attribute.

The UML object diagram can further illustrate self links. A self link occurs when an attribute of the object is an identifier of the same object.

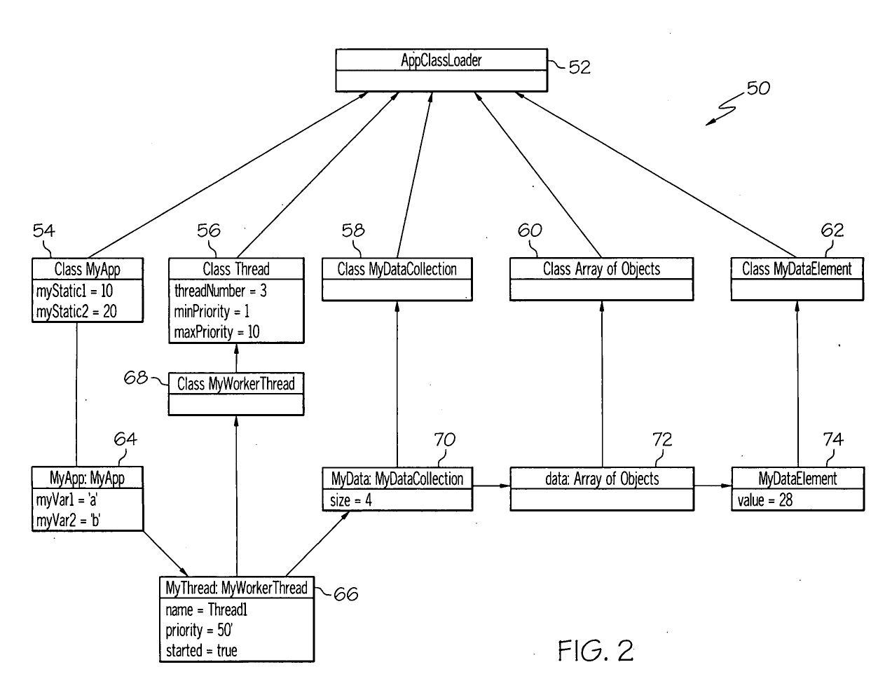

Referring to FIG. 2, an exemplary object relationship graph 50 that can be generated by the system 10 is illustrated. For purposes of understanding, each object element in the graph 50 corresponds to a software object in the software application 37. The object relationship graph 50 includes an appclassloader object element 52, a myapp class object element 54, a thread class object element 56, a mydatacollection class object element 58, an array of objects class element 60, a mydataelement class object element 62, a myapp:myapp object element 64, a mythread:myworkerthread object element 66, a myworker:thread class object element 68, a mydata:mydatacollection object element 70, a data:arrayofobjects element 72, and a mydataelement object element 74. The appclassloader object element 52 corresponds to a software object that loads the other objects identified in the graph 50. Further, each of the connecting lines in the graph 50 corresponds to a link between two objects.

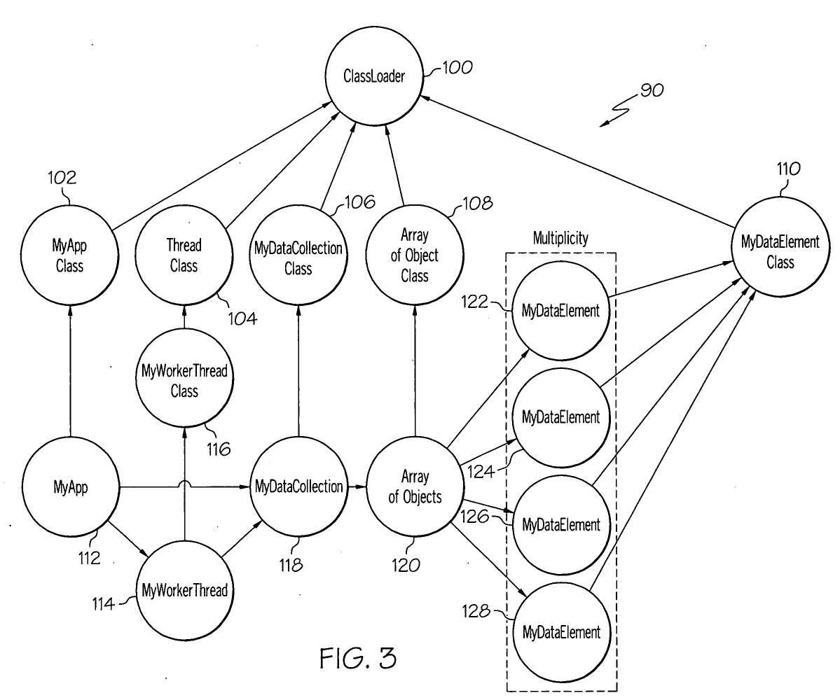

Referring to FIG. 3, a UML object diagram 90 that can be generated by system 10 is illustrated. Each object element in the UML object diagram 90 corresponds to a software object element in the object relationship graph 50. As illustrated, the UML object diagram 90 includes a class loader object element 100, a myappclass object element 102, a thread class object element 104, a mydatacollection class object element 106, an array of object class element 108, a mydataelement class object element 110, a myapp object element 112, a myworkerthread object element 114, a myworkerthread class object element 116, a mydatacollection object element 118, an array of objects element 120, and mydataelement object elements 112, 124, 126, 128. Further, each of the connecting lines in the UML object diagram 90 corresponds to a logical link between two objects.

Referring to FIGS. 2 and 3, the class loader object element 100 in the UML object diagram 90 corresponds to the appclassloader object element 52 of the object relationship graph 50. Further, the myappclass object element 102 corresponds to the myapp class object element 54, and the thread class object element 104 corresponds to the thread class object element 56. Further, the mydatacollection class object element 106 corresponds to the mydatacollection class object element 58, and the array of object class element 108 corresponds to the array of objects class element 60. Further, the mydataelement class object element 110 corresponds to the mydataelement class object element 62, and the myapp object element 112 corresponds to the myapp:myapp object element 64. Further, the myworkerthread object element 114 corresponds to the mythread:myworkerthread object element 66, and the myworkerthread class object element 116 corresponds to the myworker:thread class object element 68. Further, the mydatacollection object element 118 corresponds to the mydata:mydatacollection object element 70, and the array of objects element 120 corresponds to the data:arrayofobjects element 72. Further, the mydataelement object elements 112, 124, 126, 128 correspond to the mydataelement object element 74.

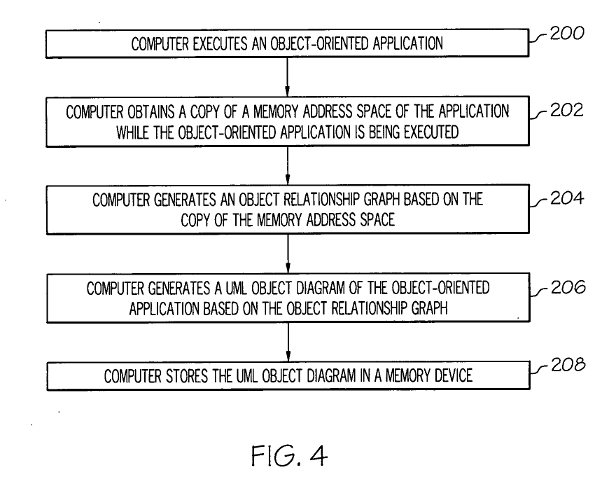

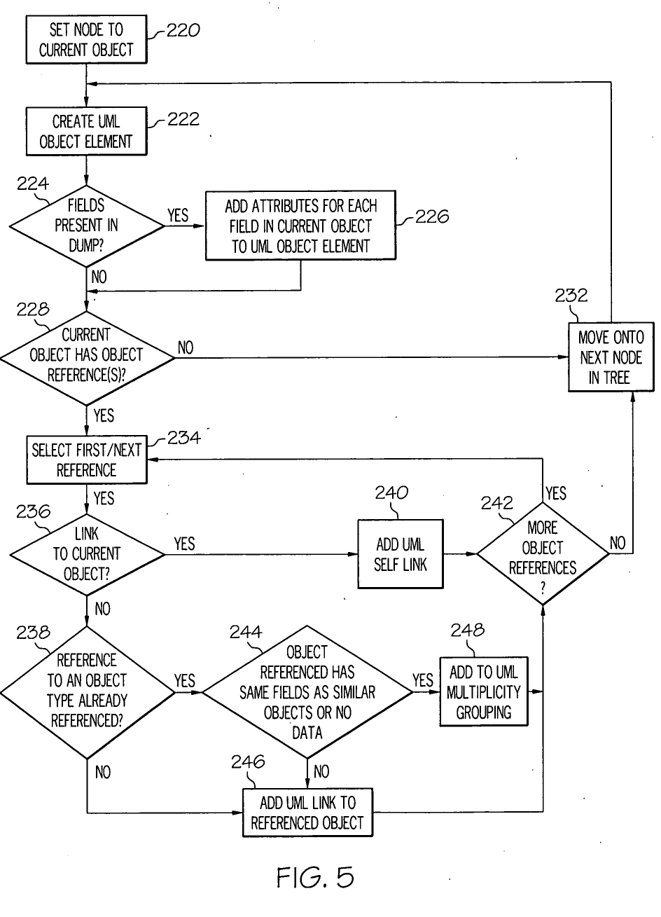

Referring to FIGS. 4 and 5, a flowchart of a method for generating a UML object diagram in accordance with another exemplary embodiment is illustrated.

At step 200, the computer 20 executes the object-oriented application 37.

At step 202, the computer 20 obtains a copy of the memory address space 36 of the application 37 while the object-oriented application 37 is being executed.

At step 204, the computer 20 generates the object relationship graph 50 based on the copy of the memory address space 36.

At step 206, the computer 20 generates the UML object diagram 90 of the object-oriented application 37 based on the object relationship graph 50.

At step 208, the computer 20 stores the UML object diagram 90 in the memory device 33.

Referring to FIG. 5, the steps for performing the step 206 will now be explained.

At step 220, the computer 20 sets a node pointer to a current software object in the object-oriented application 37.

At step 222, the computer 20 creates a UML object element that is associated with the current software object.

At step 224, the computer 20 makes a determination as to whether data fields is present in a memory dump corresponding the copied memory address space. If the value of step 224 equals “yes”, the method advances to step 226. Otherwise, the method advances to step 228.

At step 226, the computer 20 adds attributes for each field in the current object to the UML object element. After step 226, the method advances to step 228.

At step 228, the computer 20 makes a determination as to whether a current object has object references. If the value of step 228 equals “yes”, the method advances to step 234. Otherwise, the method advances to step 232.

At step 232, the computer 20 advances to the next node in the object-oriented application 37 and then the method returns to step 222.

At step 234, the computer 20 selects a first or next reference.

At step 236, the computer 20 makes a determination as to whether there is a link to the current object. In other words, whether a self-link is present. If the value of step 236 equals “yes”, the method advances to step 240. Otherwise, the method advances to step 238.

At step 240, the computer 20 adds a UML self link and then the method advances to step 242.

At step 242, the computer 20 makes a determination as to whether more object references are present. If the value of step 242 equals “yes”, the method returns to step 234. Otherwise, the method advances to step 232.

Referring again to the step 236, when the value of step 236 equals “no”, the method advances to the step 238. At step 238, the computer 20 makes a determination as to whether the reference to an object type is already referenced. If the value of step 238 equals “yes”, the method returns to the step 244. Otherwise, the method advances to step 246.

At step 244, the computer 20 makes a determination as to whether the object referenced has the same fields as similar objects or nor data. If the value of step 244 equals “yes”, the method returns to step 248. Otherwise, the method advances to step 246.

At step 248, the computer 20 adds an object element associated with the object to a UML multiplicity grouping. After step 248, the method returns to the step 242.

Referring to step 244, if the value of the step 244 equals “no”, the method advances to the step 246. At step 246, the computer 20 adds a UML link to the referenced object. After step 246, the method returns to step 242.

The above-described method can be at least partially embodied in the form of one or more computer readable media having computer-executable instructions for practicing the methods. The computer-readable media can comprise one or more of the following: floppy diskettes, CD-ROMs, hard drives, flash memory, and other computer-readable media known to those skilled in the art; wherein, when the computer-executable instructions are loaded into and executed by one or more computers the one or more computers become an apparatus for practicing the invention.

The method for generating a UML object diagram of an object-oriented application represents a substantial advantage over other methods. In particular, the method provides a technical effect of generating the UML object diagram based on a copy of a memory address space of an application while the application is being executed.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one ore more other features, integers, steps, operations, element components, and/or groups thereof.

The description of the exemplary embodiments has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated

The flowcharts depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the exemplary embodiments of the invention have been described, it will be understood that those skilled in the art, both now and in the future, may make various improvements and enhancements which fall within the scope of the claims which follow.

What is claimed is:

1. A method for generating a UML object diagram of an object-oriented application, comprising:
executing the object-oriented application;
obtaining a copy of a memory address space of the application while the object-oriented application is being executed;
generating an object relationship graph based on the copy of the memory address space;
generating the UML object diagram of the object-oriented application based on the object relationship graph;
storing the UML object diagram in a memory device.
